(19) United States
(12) Patent Application Publication
(10) Pub. No.: US 2019/0337427 A1
(43) Pub. Date: Nov. 7, 2019

(54) AIRBAG ASSEMBLY CONFIGURED TO BE STORED UNDER A VEHICLE SEAT AND TO PROVIDE A BACK-OF-LEG REACTION SURFACE WHEN DEPLOYED

(71) Applicant: GM Global Technology Operations LLC, Detroit, MI (US)

(72) Inventor: Scott D. THOMAS, Novi, MI (US)

(21) Appl. No.: 15/968,142

(22) Filed: May 1, 2018

(51) Int. Cl. B60N 2/427; B60R 21/207; B60R 21/2155; B60R 21/217; B60R 21/2338; B60R 21/239

(52) U.S. Cl. CPC B60N 2/42718; B60R 21/207; B60R 21/2155; B60R 2021/2395; B60R 21/2338; B60R 21/239; B60R 2021/23382; B60R 21/217

(57) ABSTRACT

An airbag assembly according to the present disclosure includes an airbag cushion, a cushion mount configured to mount the airbag cushion under a seat of a vehicle, and an inflator configured to inflate the airbag cushion. The airbag cushion is configured to project toward a floor of the vehicle and at least partially fill a space between a bottom surface of the seat and the floor of the vehicle when the airbag cushion is inflated to provide a reaction surface for a back surface of a leg of a passenger in the seat.

### INTRODUCTION

The information provided in this section is for the purpose of generally presenting the context of the disclosure. Work of the presently named inventor, to the extent it is described in this section, as well as aspects of the description that may not otherwise qualify as prior art at the time of filing, are neither expressly nor impliedly admitted as prior art against the present disclosure.

The present disclosure relates to airbag assemblies configured to be stored under a vehicle seat and to provide a back-of-leg reaction surface when deployed.

When a vehicle is involved in a rear impact relative to the orientation of a passenger in a vehicle, the passenger translates into the back of a seat in which the passenger is sitting, and the lower legs of the passenger typically rotate about the knees of the passenger and move toward the bottom of the seat. Most vehicles include body structure disposed below the seat that provides a reaction surface for the back of the lower legs as the lower legs rotate toward the seat bottom. Thus, the body structure prevents contact between the back of the lower legs and the seat bottom, or at least minimizes the force imparted on the back of the lower legs by the seat bottom.

### SUMMARY

An airbag assembly according to the present disclosure includes an airbag cushion, a cushion mount configured to mount the airbag cushion under a seat of a vehicle, and an inflator configured to inflate the airbag cushion. The airbag cushion is configured to project toward a floor of the vehicle and at least partially fill a space between a bottom surface of the seat and the floor of the vehicle when the airbag cushion is inflated to provide a reaction surface for a back surface of a leg of a passenger in the seat.

In one example, the airbag cushion is configured to project toward the floor of the vehicle and forward of the seat when the airbag cushion is inflated.

In one example, the airbag assembly further includes at least one tether disposed within the airbag cushion and attaching a first portion of an inner surface of the airbag cushion to at least one of the cushion mount and a second portion of the inner surface of the airbag cushion adjacent to the bottom surface of the seat.

In one example, the at least one tether includes at least one of a first tether and a second tether, the first tether attaching a rear portion of the inner surface of the airbag cushion to the second portion of the inner surface of the airbag cushion, the second tether attaching a front portion of the inner surface of the airbag cushion to the second portion of the inner surface of the airbag cushion.

In one example, the at least one tether includes the first tether, the second tether, and a third tether, the third tether attaching a bottom portion of the inner surface of the airbag cushion to the second portion of the inner surface of the airbag cushion.

In one example, the airbag assembly further includes a tethered vent configured to (i) remain open to release gas from an interior of the airbag cushion when an object is in a deployment path of the airbag cushion, and (ii) close to prevent gas from escaping the interior of the airbag cushion when the airbag cushion is fully deployed.

In one example, the airbag assembly further includes an upper housing and a lower housing configured to cooperate with the upper housing to fully enclose the airbag cushion.

In one example, the airbag assembly further includes a deployment door configured to (i) remain closed and cover a bottom surface of the airbag cushion when the airbag cushion is uninflated, and (ii) open in a direction away from the leg of the passenger and allow the airbag cushion to project toward the floor and at least partially fill the space between the bottom surface of the seat and the floor when the airbag cushion is inflated.

In one example, the airbag assembly further includes a housing configured to at least partially enclose the airbag cushion when the airbag cushion is uninflated, where the deployment door is part of the housing.

In one example, the cushion mount includes a mounting plate and a plurality of fasteners configured to extend through the mounting plate, through the airbag cushion, and into a frame of a bottom portion of the seat to secure the airbag cushion to the seat.

In one example, the airbag cushion is configured to project upward into a bottom cushion of the seat to raise a thigh of the passenger when the airbag cushion is inflated to prevent the passenger from sliding forward underneath a seat belt of the seat.

In one example, the airbag assembly further includes a cover configured to (i) separate the airbag cushion from the bottom cushion of the seat when the airbag cushion is uninflated, and (ii) tear to allow the airbag cushion to contact the bottom cushion of the seat when the airbag cushion is inflated.

In one example, the airbag assembly further includes an inflator control module configured to control the inflator to deploy the airbag cushion when the vehicle is involved in at least one of a rear impact and a front impact relative to the passenger and a magnitude of the at least one of the rear impact and the front impact is greater than a predetermined value.

In one example, the airbag assembly further includes an inflator control module configured to control the inflator to deploy the airbag cushion when an occupant is present in the seat, the vehicle is involved in at least one of a rear impact and a front impact relative to the occupant, and a magnitude of the at least one of the rear impact and the front impact is greater than a predetermined value.

In one example, the airbag assembly further includes an inflator control module configured to control the inflator to not deploy the airbag cushion when an occupant is not present in the seat.

In one example, the airbag assembly further includes at least one tether disposed within the airbag cushion and attaching a left side portion of an inner surface of the airbag cushion to a right side portion of the inner surface of the airbag cushion.

A second airbag assembly according to the present disclosure includes an airbag cushion including an upper portion and a lower portion, a cushion mount configured to mount the airbag cushion under a seat of a vehicle, and an inflator configured to inflate the airbag cushion. The upper portion of the airbag cushion is configured to project upward into a bottom cushion of the seat to raise a thigh of a passenger in the seat when the airbag cushion is inflated to prevent the passenger from sliding forward underneath a seat belt of the seat. The lower portion of the airbag cushion is configured to project toward a floor of the vehicle and at least partially fill a space between a bottom surface of the seat and the floor of the vehicle when the airbag cushion is inflated.

In one example, the second airbag assembly further includes a cover configured to (i) separate the airbag cushion from the bottom cushion of the seat when the airbag cushion is uninflated, and (ii) tear to allow the airbag cushion to contact the bottom cushion of the seat when the airbag cushion is inflated.

In one example, the cushion mount includes a pair of mounting strips and a plurality of fasteners configured to extend through the pair of mounting strips, through the airbag cushion, and into a frame of a bottom portion of the seat to secure the airbag cushion to the seat.

In one example, the cushion mount includes a mounting plate and a plurality of fasteners configured to extend through the mounting plate, through the airbag cushion, and into a frame of a bottom portion of the seat to secure the airbag cushion to the seat.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side view of an airbag assembly according to the present disclosure installed under a vehicle seat;

FIG. 2 is a perspective view of the airbag assembly of FIG. 1;

FIG. 3 is an exploded perspective view of the airbag assembly of FIG. 1;

FIG. 4 is a side view of the airbag assembly of FIG. 1 shown with a vent according to the present disclosure;

FIG. 5 is a side view of the airbag assembly of FIG. 4 with the vent in an open position;

FIG. 6 is a side view of the airbag assembly of FIG. 4 with the vent in a closed position;

FIG. 7 is a section view of another airbag assembly according to the present disclosure installed under a vehicle seat with an airbag cushion of the airbag assembly in an uninflated state;

FIG. 8 is a section view of the airbag assembly of FIG. 7 with the airbag cushion in an inflated state;

FIG. 9 is a perspective view of components of the airbag assembly of FIG. 7 including the airbag cushion in the uninflated state and a cushion mount attaching the airbag cushion to a seat bottom structure;

FIG. 10 is an exploded perspective view of the cushion mount of FIG. 9 illustrating a pair of mounting strips included in the cushion mount;

FIG. 11 is a cushion mounting plate according to the present disclosure;

FIG. 12 is a perspective view of the airbag cushion of FIG. 7 in an inflated state;

FIG. 13 is a perspective view of components of the airbag assembly of FIG. 7 including the airbag cushion in an inflated state and a lower housing that cooperates with the bottom of the vehicle seat to enclose the airbag cushion;

FIG. 14 is a functional block diagram of an example airbag control module according to the present disclosure; and

FIG. 15 is a flowchart illustrating an example method for controlling an airbag assembly according to the present disclosure.

In the drawings, reference numbers may be reused to identify similar and/or identical elements.

### DETAILED DESCRIPTION

In the future, some vehicles such as autonomous vehicles may have seating arrangements that provide a large storage cavity under a seat. Thus, if such a vehicle is involved in a rear impact, the vehicle may not include body structure disposed below the seat that provides a reaction surface for the backs of lower legs as the lower legs rotate toward the seat due to the rear impact. Therefore, the present disclosure describes an airbag that is stored under a seat and inflates toward the floor of a vehicle and forward of the seat to provide a reaction surface for the backs of the lower legs of a passenger in the seat. In one example, the airbag is stored entirely within the bottom of the seat (i.e., the airbag does not protrude beyond the bottommost surface of the seat) so as not to affect styling or decrease the size of a storage cavity between the seat and the floor of the vehicle.

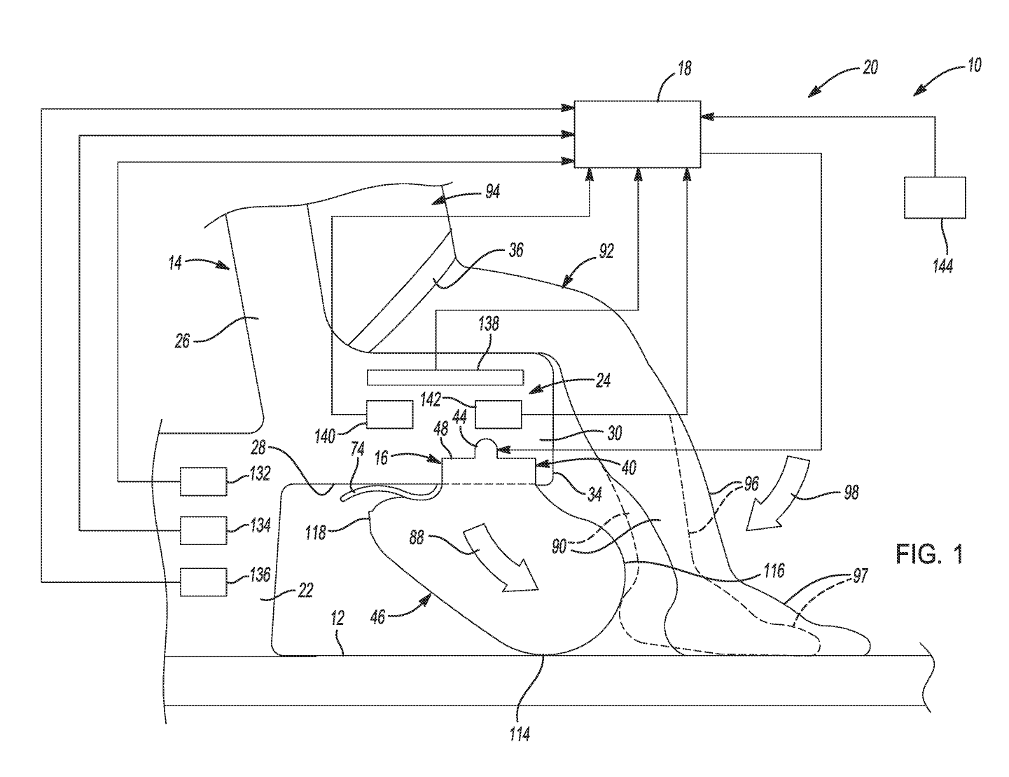

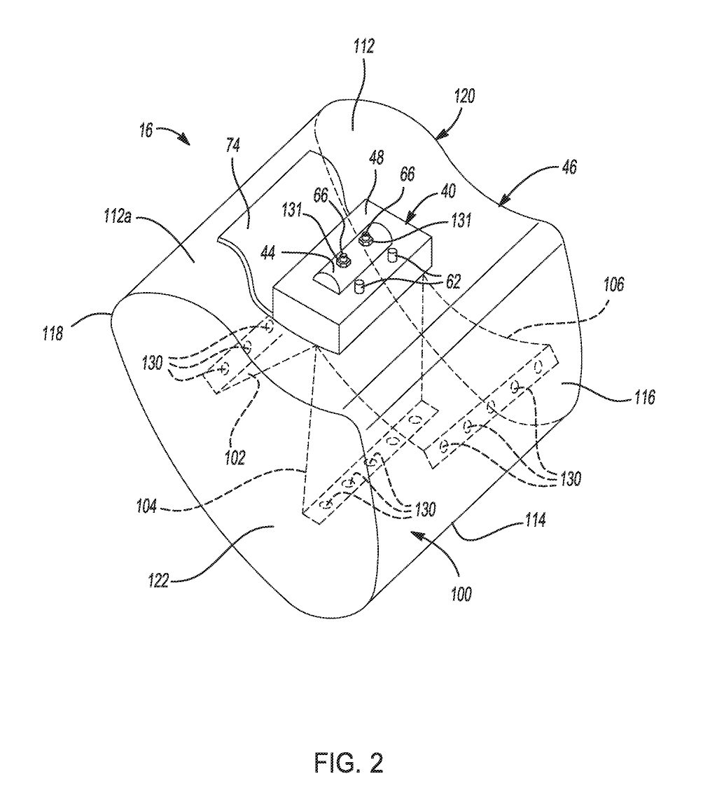

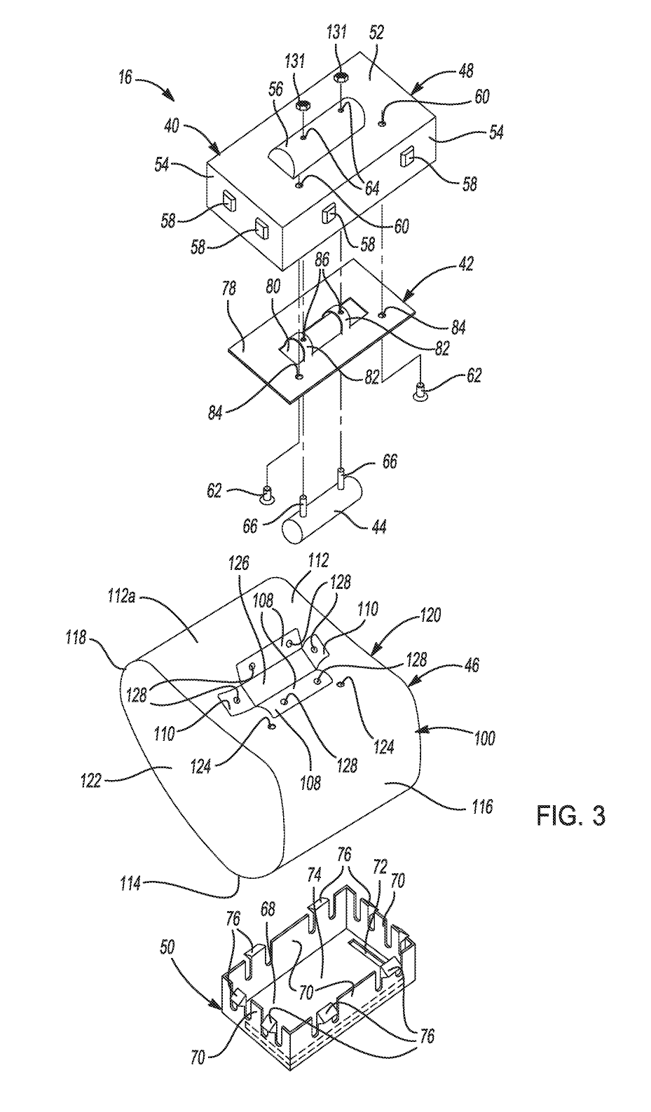

Referring now to FIGS. 1-3, an example vehicle 10 according to the present disclosure includes a floor panel 12, a seat 14, an airbag assembly 16, and an airbag control module 18. The floor panel 12 forms a bottom surface of a passenger compartment 20 of the vehicle 10. Although the airbag control module 18 is shown in the passenger compartment 20, the airbag control module 18 may be located in another area of the vehicle 10 such as in an instrument panel (not shown) of the vehicle 10. The floor panel 12 may be made from one or more materials including plastic and/or metal. The vehicle 10 may be an autonomous vehicle.

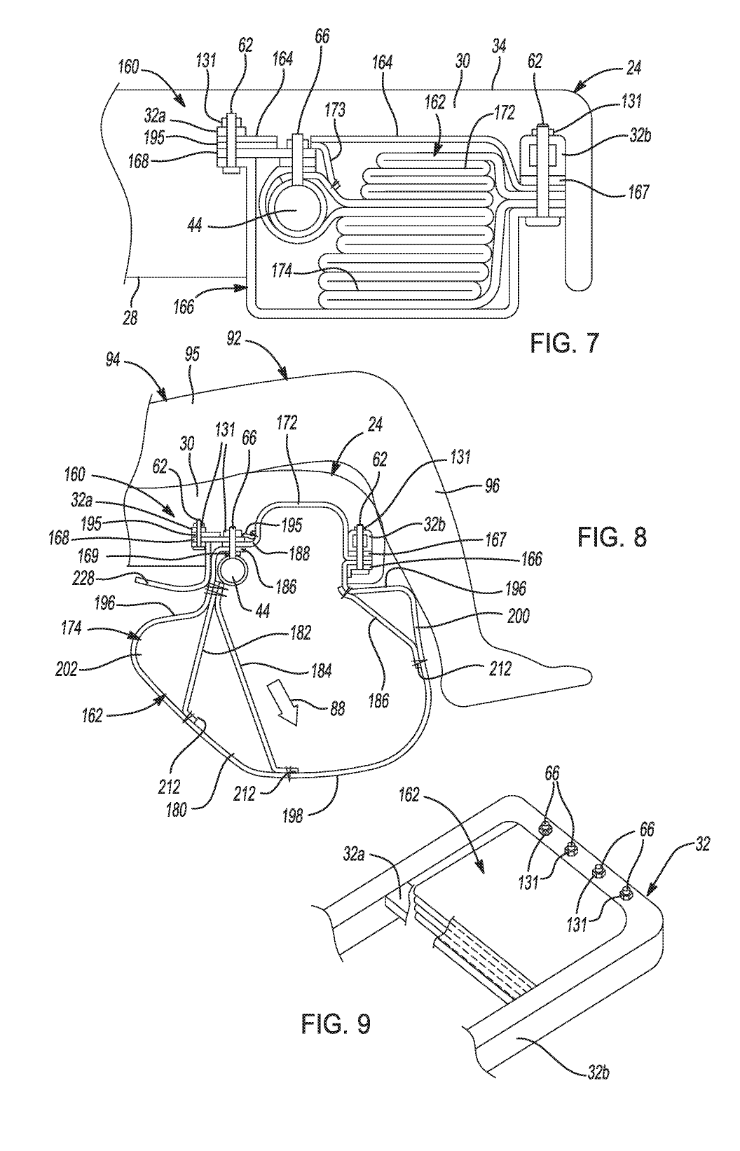

The seat 14 includes a base 22, a bottom 24 and a back 26. Alternatively, the base 22 may be omitted, and the seat 14 can be mounted to a structure of the vehicle 10, such as a vehicle sidewall, a lateral wall around the perimeter of the seat 14, or a center console, at a location above the floor panel 12. The bottom 24 of the seat 14 has an underside or bottom surface 28 and includes a cushion 30, a frame 32 (FIGS. 7-9) disposed within or below the cushion 30, and a cover 34 covering the outer surface of the cushion 30. A seatbelt 36 extends around a passenger 94 to restrain the passenger 94 in the seat 14. The seatbelt 36 may be fixed to the bottom 24 of the seat 14 as shown, to another structural component of the seat 14 such as the base 22 of the seat 14, or to a body structure of the vehicle 10 such as the floor panel 12, a vehicle sidewall, a center console, or a vehicle cross member.

The airbag assembly 16 is mounted under the seat 14 and is attached to the frame 32 of the bottom 24 of the seat 14. The airbag assembly 16 includes a housing assembly 40, a mounting plate 42, an inflator 44, and an airbag cushion 46. The housing assembly 40 may be made from metal (e.g., aluminum), plastic, a composite, a polymer, or a combination of plastic and polymer such as thermoplastic olefin (TPO). The housing assembly 40 contains the airbag cushion 46 before the airbag cushion 46 is deployed.

The housing assembly 40 includes an upper housing 48 and a lower housing 50 that cooperates with the upper housing 48 to fully enclose the airbag cushion 46. The upper housing 48 includes a top wall 52 and a plurality of sidewalls 54. The top wall 52 of the upper housing 48 forms an inflator pocket 56, and each of the sidewalls 54 of the upper housing 48 forms a pair of tab receptacles 58. The inflator pocket 56 receives an upper portion (e.g., an upper half) of the inflator 44 when the airbag assembly 16 is assembled. The inflator pocket 56 is shaped to accommodate the upper portion of the inflator 44. The top wall 52 of the upper housing 48 defines a pair of holes 60 that receive a pair of screws 62, and the inflator pocket 56 defines a pair of holes 64 that receive threaded posts 66 on the inflator 44.

The lower housing 50 includes a bottom wall 68 and a plurality of sidewalls 70. The bottom wall 68 of the lower housing 50 includes a weakened portion 72 that defines a U-shaped tear seam, which forms the boundary of a deployment door 74 for the airbag cushion 46. The deployment door 74 remains closed and covers the bottom surface of the airbag cushion 46 when the airbag cushion 46 is uninflated. The deployment door 74 opens in a direction away from the legs 92 of the passenger 94 and allows the airbag cushion 46 to project in the direction 88 toward the floor panel 12 and forward of the seat 14 when the airbag cushion 46 is inflated. The deployment door 74 may be part of the lower housing 50 as shown, or the deployment door 74 may be part of the seat 14 (e.g., the deployment door 74 may form part of the bottom surface 28 of the seat 14). Although the upper and lower housings 48 and 50 are depicted as separate pieces, the upper and lower housings 48 and 50 may be made from the same piece of material with a living hinge (not shown) therebetween. In addition, the weakened portion 72 of the bottom wall 68 of the lower housing 50 can be part of the living hinge.

Each of the sidewalls 70 of the lower housing 50 includes a pair of flexible tabs 76. When the airbag assembly 16 is assembled, the sidewalls 54 of the upper housing 48 fit inside of the sidewalls 70 of the lower housing 50, and the flexible tabs 76 on the lower housing 50 snap into the tab receptacles 58 in the upper housing 48 to join the upper and lower housings 48 and 50 together via a snap fit. In addition, when the airbag assembly 16 is assembled, the bottom wall 68 of the lower housing 50 may be flush with the bottom surface 28 of the seat 14 so that the airbag assembly 16 does not protrude into the space between the floor panel 12 and the seat 14. The weakened portion 72 may be located on the flexible tabs 76 instead of or in addition to being located on the bottom wall 68 such that, when the airbag cushion 46 is deployed, the tabs 76 separate from the remainder of the sidewalls 70 to detach the lower housing 50 from the upper housing 50. In this regard, the entire lower housing 50 may act as a deployment door for the airbag cushion 46.

The mounting plate 42 mounts the airbag cushion 46 under the seat 14. Thus, the mounting plate 42 may be referred to as a cushion mount. The mounting plate 42 can be positioned within the airbag cushion 46 or outside of the airbag cushion 46 when the airbag assembly 16 is assembled. The mounting plate 42 includes a flat, generally rectangular portion 78 that defines a rectangular opening 80, and a pair of U-shaped braces 82 that extend across the rectangular opening 80. The flat rectangular portion 78 of the mounting plate 42 defines a pair of holes 84 that receive the screws 62. The U-shaped braces 82 receive the upper portion of the inflator 44 and define a pair of holes 86 that receive the threaded posts 66 on the inflator 44.

When the airbag cushion 46 is inflated as shown in FIG. 1, the airbag cushion 46 projects in a direction 88 toward the floor panel 12 of the vehicle 10 and at least partially fills the space between the bottom surface 28 of the seat 14 and the floor panel 12 of the vehicle 10. In addition, when the airbag cushion 46 is inflated, the airbag cushion 46 may project in a longitudinal (e.g., fore-aft) direction of the vehicle and forward of the seat 14 to provide a reaction surface for back surfaces 90 of legs 92 of the passenger 94 at a location that is forward of the seat 14. Thus, when the vehicle 10 is involved in a rear impact that causes lower portions (e.g., calves) 96 of the legs 92 of the passenger 94 and feet 97 of the passenger 94 to move in a direction 98 toward the seat 14, the airbag cushion 46 may prevent the lower portion 96 of the legs 92 from contacting the seat 14. Alternatively, when the vehicle 10 is involved in a rear impact, the airbag cushion 46 may at least minimize an impact force between the lower portions 96 of the leg 90 and the seat 14. As used herein, the phrase “rear impact” is used to refer to an impact to the vehicle 10 at a location that is rearward of the passenger 94. Thus, if the passenger 94 is facing the front end of the vehicle 10, a rear impact may be an impact to the rear end of the vehicle 10. Conversely, if the passenger 94 is facing toward the rear end of the vehicle 10, a rear impact may be an impact to the front end of the vehicle 10. In addition, if the passenger 94 is facing one side of the vehicle 10, a rear impact may be an impact to the opposite side of the vehicle 10.

The airbag cushion 46 includes an outer shell 100, a first tether 102, a second tether 104, a third tether 106, a pair of first flaps 108, and a pair second flaps 110. The outer shell 100 of the airbag cushion 46 has a top surface 112, a bottom surface 114, a front surface 116, a rear surface 118, a left side surface 120, and a right side surface 122. In addition, the outer shell 100 defines a pair of holes 124 and a rectangular opening 126 that extend through the top surface 112. The holes 124 in the top surface 112 of the airbag cushion 46 receive the screws 62. The first and second flaps 108 and 110 extend from sides of the rectangular opening 126 and define holes 128 that receive the threaded posts 66 on the inflator 44.

The first, second, and third tethers 102, 104, and 106 are disposed within the interior of the airbag cushion 46 defined by the outer shell 100. The first tether 102 attaches the rear surface 118 of the airbag cushion 46 to the mounting plate 42 and/or to a first portion of the airbag cushion 46 disposed adjacent to the bottom surface 28 of the seat 14 (e.g., a portion of the top surface 112 of the airbag cushion 46 surrounding the rectangular opening 126). The second tether 104 attaches the bottom surface 114 of the airbag cushion 46 to the mounting plate 42 and/or to the first portion of the airbag cushion 46. The third tether 106 attaches the front surface 116 of the airbag cushion 46 to the mounting plate 42 and/or to the first portion of the airbag cushion 46. The first, second, and third tethers 102, 104, and 106 may be joined to the outer shell 100 of the airbag cushion 46 using stitching 130. The first, second, and third tethers 102, 104, and 106 may be joined to the mounting plate 42 using fasteners (not shown). When the first, second, or third tether 102, 104, or 106 is described as being joined to an outer surface of the airbag cushion 46, it should be understood that the first, second, or third tether 102, 104, or 106 is also joined to a corresponding portion of the inner surface of the airbag cushion 46 opposite of that outer surface.

The shape of the outer shell 100 of the airbag cushion 46 and the lengths of the first, second, and third tethers 102, 104, and 106 enable the airbag cushion 46 to project in the direction 88 and forward of the seat 14 when the airbag cushion 46 is inflated. To this end, the length of the second tether 104 may be greater than the length of the first tether 102 so that the bottom surface 114 of the airbag cushion 46 projects from the housing assembly 40 by a greater distance than the rear surface 118 of the airbag cushion 46. In addition, the length of the third tether 106 may be greater than the length of the first tether 102 so that the front surface 116 of the airbag cushion 46 projects from the housing assembly 40 by a greater distance than the rear surface 118 of the airbag cushion 46. Further, the length of the third tether 106 may be selected to ensure that the airbag cushion 46 projects forward of the seat 14 when the airbag cushion 46 is deployed. Moreover, a rear portion 112a of the top surface 112 of the airbag cushion 46 may react against (e.g., contact) the bottom surface 28 of the seat 14 so that the cushion 46 does not rotate when it is contacted by the legs 92 of the passenger 94.

With continued reference to FIGS. 1-3, a method of assembling the airbag assembly 16 will now be described. First, the screws 62 are inserted through the holes 84 in the mounting plate 42 and are secured within the holes 84 using a mechanical fastening technique such as a press fit. The inflator 44 is then inserted into the rectangular opening 80 in the mounting plate 42 and is received in the U-shaped braces 82 of the mounting plate 42. As the inflator 44 is received in the U-shaped braces 82, the threaded posts 66 on the inflator 44 are inserted through holes 86 in the U-shaped braces 82. Pressed-on washers (not shown) or a snap fit may be used to hold the inflator 44 to the mounting plate 42. Then, the mounting plate 42 and the inflator 44 are inserted through the rectangular opening 126 in the uninflated airbag cushion 46 and into the interior of the airbag cushion 46 so that the screws 62 are received in the holes 124 in the airbag cushion 46. After or possibly before the mounting plate 42 and the inflator 44 are inserted into the airbag cushion 46, the airbag cushion 46 may be folded or rolled so that the airbag cushion 46 fits inside of the housing assembly 40.

After the mounting plate 42 and the inflator 44 are inserted into the airbag cushion 46, the first and second flaps 108 and 110 are folded over the mounting plate 42 and the inflator 44. The first and second flaps 108 and 110 are folded over so that the threaded posts 66 on the inflator 44 are received in the holes 128 in the first and second flaps 108 and 110. The first flaps 108 may be folded over the mounting plate 42 and the inflator 44 before the second flaps 110 are folded over the inflator 44 or vice versa. Then, the mounting plate 42, the inflator 44, and the airbag cushion 46 are inserted into the upper housing 48 so that the screws 62 are received in the holes 60 in the upper housing 48 and the threaded posts 66 on the inflator 44 are received in the holes 64 on the upper housing 48. The mounting plate 42, the inflator 44, and the airbag cushion 46 may then be secured to the upper housing 48 by tightening nuts 131 onto the threaded posts 66.

Next, the screws 62 are inserted into holes in the frame 32 of the seat 14 (as shown in FIG. 7) and fastened via the nuts 131 to secure the mounting plate 42, the inflator 44, the airbag cushion 46, and the upper housing 48 to the seat frame 32. Alternatively, the holes in the seat frame 32 may be threaded and the screws 62 may be held in place therein by threaded engagement between the screws 62 and the holes. Alternatively, the screws 62 may be held in place in the holes in the seat frame 32 by a press fit between the screws 62 and the holes.

Finally, the lower housing 50 is inserted over the upper housing 48 to fully enclose the airbag cushion 46 within the housing assembly 40. As the lower housing 50 is inserted over the upper housing 48, the flexible tabs 76 on the lower housing 50 engage the outer surfaces of the sidewalls 54 of the upper housing 48 and ride alongside the sidewalls 54 as the upper and lower housings 48 and 50 are brought together. Once the heads of the flexible tabs 76 are aligned with the tab receptacles 58 in the sidewalls 54 of the upper housing 48, the flexible tabs 76 flex inward so that the heads of the flexible tabs 76 are received in the tab receptacles 58. In turn, the lower housing 50 is secured to the upper housing assembly 40 via a snap fit, and the airbag assembly 16 is fully assembled. In various implementations, the upper and lower housings 48 and 50 may be joined together before the airbag assembly 16 is installed into the seat 14.

The airbag control module 18 controls the inflator 44 to deploy the airbag cushion 46 when the vehicle 10 is involved in an impact or collision. The airbag control module 18 determines whether the vehicle 10 is involved in an impact based on an input from one or more accelerometers 132, one or more pressure sensors 134, and/or one or more gyroscopes 136. Each accelerometer 132 measures the acceleration of the vehicle 10 and outputs a signal indicating the vehicle acceleration. Each pressure sensor 134 measures the pressure of air within a structural component of the vehicle 10 and outputs a signal indicating the air pressure. Although FIG. 1 depicts the pressure sensor(s) 134 located in the base 22 of the seat 14, the pressure sensor(s) 134 may be positioned in an outer structural component of the vehicle such as in a sidewall or door (not shown) of the vehicle 10. Likewise, the accelerometers 132 and/or their gyroscopes 136 may be positioned in the vehicle 10 at locations that are different than the locations shown in FIG. 1. Each gyroscope 136 measures the angular velocity of the vehicle 10 and outputs a signal indicating the vehicle angular velocity.

The airbag control module 18 may control the inflator 44 to deploy the airbag cushion 46 when the vehicle 10 is involved in an impact if the magnitude of the impact is greater than a predetermined value. Conversely, the airbag control module 18 may control the inflator 44 to not deploy the airbag cushion 46 when the vehicle 10 is involved in an impact if the magnitude of the impact is less than the predetermined value or an occupant is not present in the seat 14. The airbag control module 18 may determine whether an occupant is present in the seat 14 based on an input from one or more (e.g., all) of a weight sensor 138, a capacitive sensor 140, a pressure sensor 142, a camera 144, and another type of sensor (not shown). The weight sensor 138 measures the weight of an object present in the seat 14 and generates a signal indicating the weight. The capacitive sensor 140 measures the capacitance of an object present in the seat 14 and generates a signal indicating the capacitance. The pressure sensor 142 measures the pressure applied to the bottom 24 of the seat 14 by an object resting thereon and generates a signal indicating the seat pressure.

The camera 144 obtains an image of an object present in the seat 14 and/or and generates a signal indicating the image. The camera 144 can be mounted on an interior roof (not shown) of the vehicle 10, a sidewall (not shown) of the vehicle 10, or other locations in the vehicle 10 that provide a suitable mounting surface and field of view for the camera 144. Other technologies for sensing the presence of an occupant may be used in addition to or instead of those discussed above.

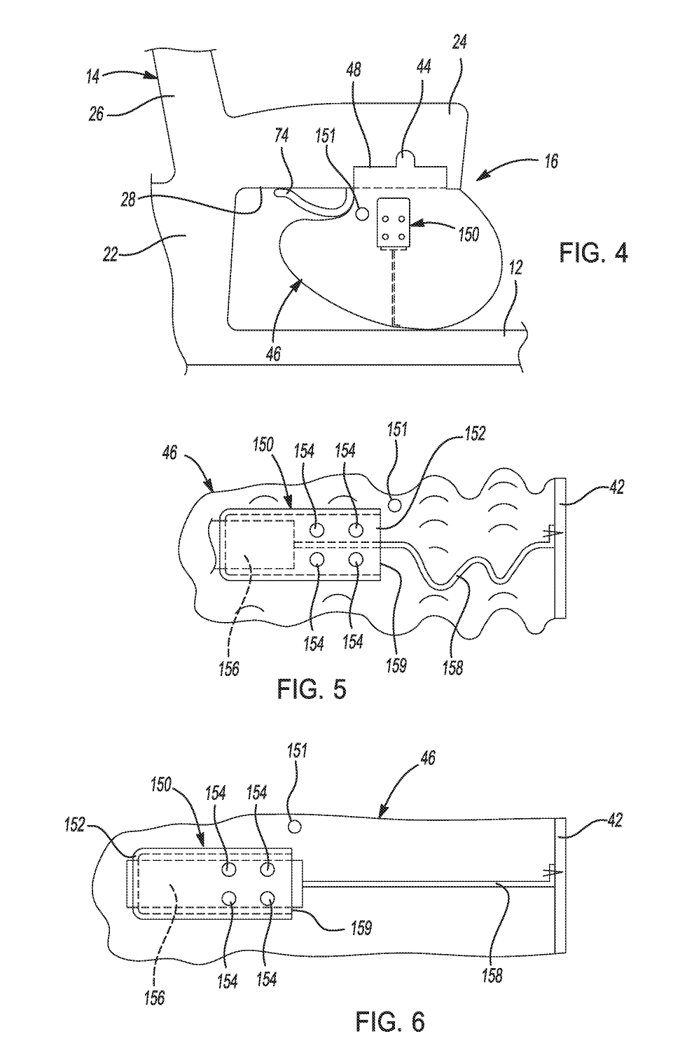

Referring now to FIGS. 4-6, the airbag assembly 16 may further include a tethered vent 150. The tethered vent 150 includes a flexible guide plate 152 that is stitched or otherwise mechanically attached to the airbag cushion 46, holes 154 in the guide plate 152 and the airbag cushion 46, a cover 156, and a tether 158. A pouch 159 is formed between the airbag cushion 46 and the guide plate 152, and the cover 156 is located in the pouch 159. The guide plate 152 is attached to the airbag cushion 46, and the holes 154 in the guide plate 152 and the airbag cushion 46 allow gas to exit the airbag cushion 46 when the airbag cushion 46 is not fully deployed as shown in FIG. 5. Thus, the tethered vent 150 remains open to release gas from the interior of the airbag cushion 46 if deployment of the airbag cushion 46 is blocked (i.e., an object is in a deployment path of the airbag cushion 46).

The cover 156 may be folded upon itself, slidably coupled to the guide plate 152 or the airbag cushion 46 and cover the holes 154 to prevent gas from escaping the airbag cushion 46 when the airbag cushion 46 is fully deployed as shown in FIG. 6. One end of the tether 158 is attached to the cover 156, and the other end of the tether 158 is attached to the mounting plate 42, as shown in FIGS. 5 and 6, or to the airbag cushion 46, as shown in FIG. 4. The cover 156 or the tether 158 may be tack stitched to the guide plate 152, the airbag cushion 46, or both the guide plate 152 and the airbag cushion 46. Alternatively, tear tabs (not shown) can be located at the interface between the cover 156 and the guide plate 152 or the airbag cushion 46 for temporary retention of the cover 156. The tether 158 connects the cover 156 to the mounting plate 42 or the airbag cushion 46 so that, when the airbag cushion 46 is fully deployed, the cover 156 is pulled by the tether 158, the tack stitching or tear tabs rip(s), and the cover 156 slides within the guide plate 152 from the position shown in FIG. 5 to the position shown in FIG. 6. Thus, the tethered vent 150 closes to prevent gas from escaping the interior of the airbag cushion 46 when the airbag cushion 46 is fully deployed. Other forms of tethered vents found within the airbag industry can be substituted for the tethered vent 150. In addition, one or more discrete vents 151 that are always open can be included in the airbag cushion 46 to enable gas to escape the cushion 46 in a controlled manner.

Referring now to FIGS. 7-13, an airbag assembly 160 is substantially similar to the airbag assembly 16 except that the airbag assembly 160 includes an airbag cushion 162 that projects upward into the bottom cushion 30 of the seat 14 and raises upper portions 95 (e.g., thighs) of the legs 92 when the airbag cushion 162 is inflated. This prevents the passenger 94 from sliding forward underneath the seatbelt 36 (FIG. 1) when, for example, the vehicle 10 is involved in a front impact. As used herein, the phrase “front impact” is used to refer to an impact to the vehicle 10 at a location that is in front of the passenger 94. Thus, if the passenger 94 is facing the front end of the vehicle 10, a front impact may be an impact to the front end of the vehicle 10. Conversely, if the passenger 94 is facing toward the rear end of the vehicle 10, a front impact may be an impact to the rear end of the vehicle 10. In addition, if the passenger 94 is facing one side of the vehicle 10, a front impact may be an impact to that side of the vehicle 10.

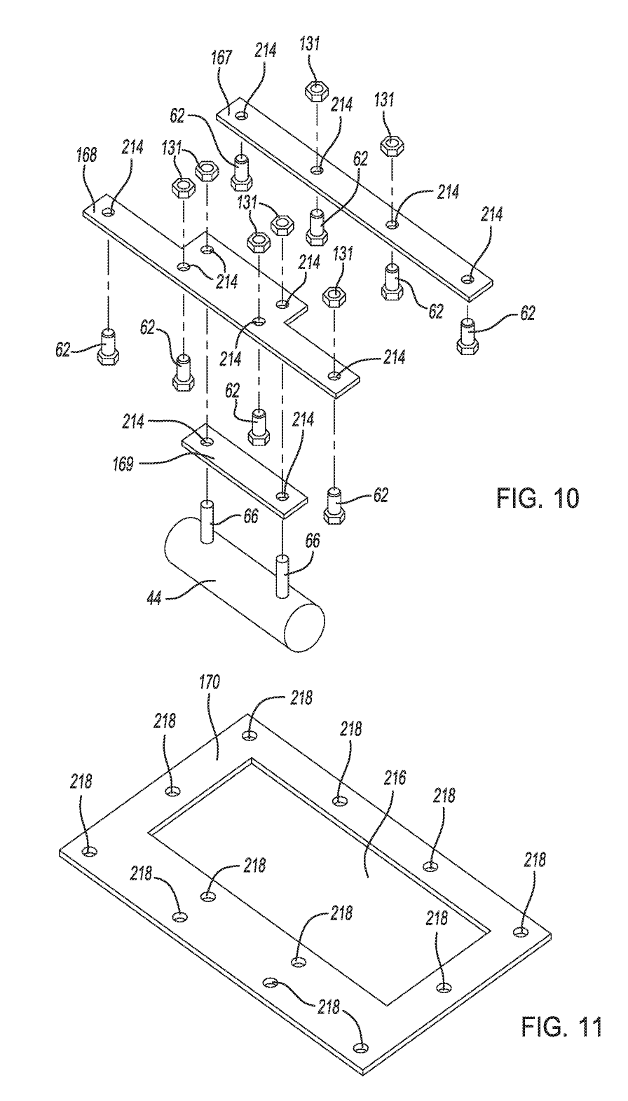

In addition, while the airbag assembly 16 includes the upper and lower housings 48 and 50 that cooperate to enclose the airbag cushion 46, the airbag assembly 160 includes a tearable (e.g. fabric) cover 164 and a lower housing 166 that cooperate to enclose the airbag cushion 162. Further, in place of the mounting plate 42, the airbag assembly 160 includes a first mounting strip 167, a second mounting strip 168, and a third mounting strip 169 (FIG. 10). Alternatively, the airbag assembly 160 may include a mounting plate 170 (FIG. 11) having the shape of a picture frame. In various implementations, in place of the tearable cover 164 and the lower housing 166, the airbag assembly 160 may include one or more housings that are similar or identical to the upper and lower housings 48 and 50 of the airbag assembly 16. Some of the housings described herein, such as the upper housing 48, may be part of the seat 14 and/or formed integrally with structure of the seat 14.

The airbag cushion 162 includes an upper portion 172 and a lower portion 174. The upper portion 172 of the airbag cushion 162 projects upward into the bottom cushion 30 of the seat 14 when the airbag cushion 162 is inflated. The lower portion 174 of the airbag cushion 162 projects in the direction 88 toward the floor panel 12 of the vehicle 10 and forward of the seat 14 when the airbag cushion 162 is inflated. For ease of discussion, the upper and lower portions 172 and 174 of the airbag cushion 162 are referred to below as upper and lower cushions 172 and 174.

The lower cushion 174 of the airbag assembly 160 is substantially similar to the airbag cushion 46 of the airbag assembly 16. In this regard, the lower cushion 174 includes an outer shell 180, a first tether 182, a second tether 184, a third tether 186, a pair of first flaps 188, and a pair second flaps 190. The outer shell 180, the first tether 182, the second tether 184, the third tether 186, the first flaps 188, and the second flaps 190 of the airbag assembly 160 are substantially similar or identical to the outer shell 100, the first tether 102, the second tether 104, the third tether 106, the first flaps 108, and the second flaps 110 of the airbag assembly 16, respectively.

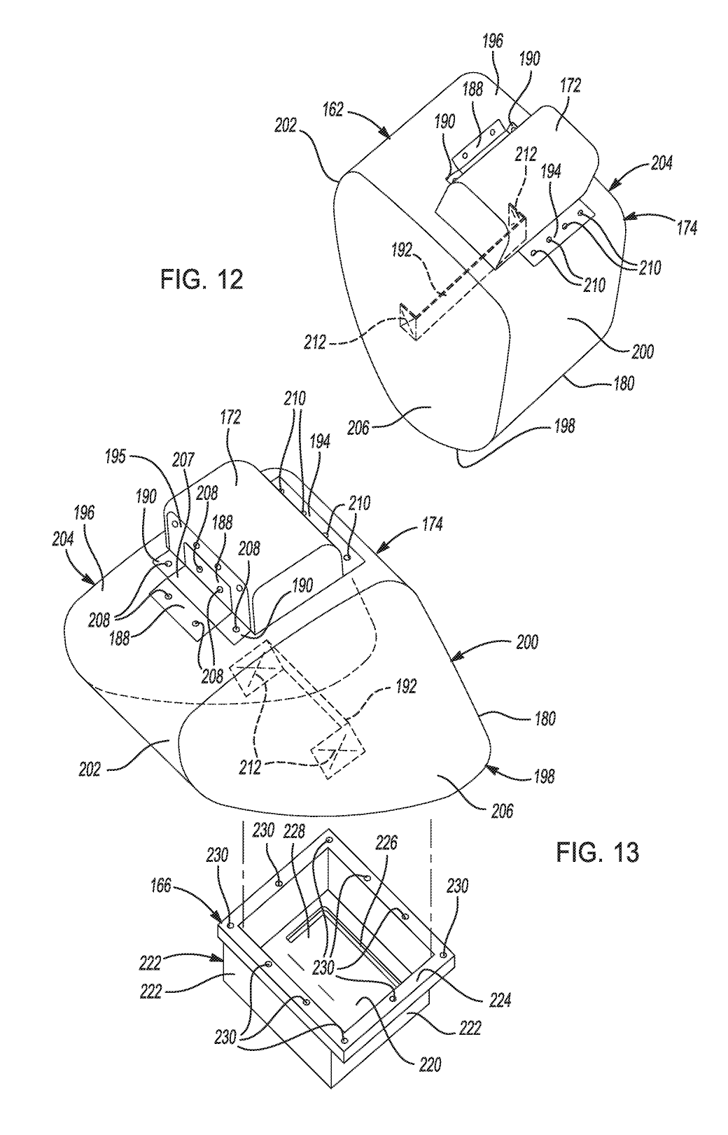

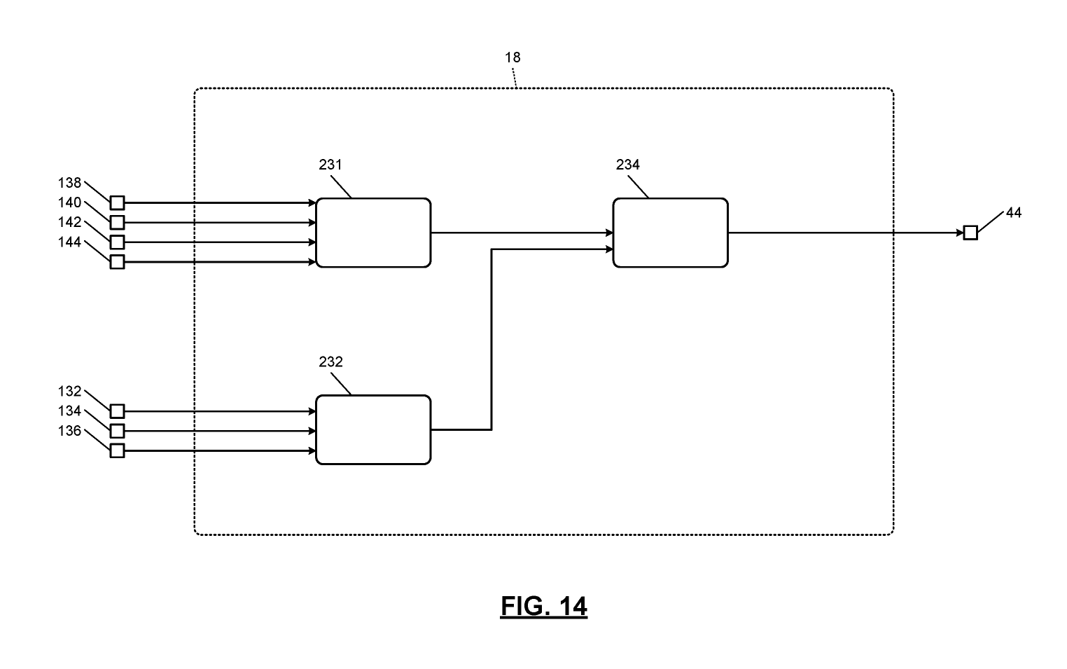

In contrast to the airbag cushion 46 of the airbag assembly 16, the lower cushion 174 of the airbag assembly 160 further includes a fourth tether 192, a third flap 194, and a fourth flap 195. However, the airbag cushion 46 of the airbag assembly 16 may also include the fourth tether 192. Although the lower cushion 174 is described as including the first, second, third, and fourth tethers 182, 184, 186, and 192, the first, second, third tethers 182, 184, and 186 are not shown in FIGS. 12 and 13 in order to better illustrate the fourth tether 102. The fourth tether 192 spans the width of the lower cushion 174 and a lateral (e.g. cross-car) direction of the vehicle 10. The fourth tether 192 is used to control the shape of the lower cushion 174 in the lateral direction. Optionally, more than one tether can be used to control the lateral cushion shape. The first and second flaps 188 and 190 are disposed on one side of the upper cushion 172, the third flap 194 is disposed on the other side of the upper cushion 172, and the fourth flap 195 is disposed near one of the first flaps 188.

The outer shell 180 of the lower cushion 174 has a top surface 196, a bottom surface 198, a front surface 200, a rear surface 202, a left side surface 204, and a right side surface 206. In addition, the outer shell 180 defines a rectangular opening 207 that extend through the top surface 196. The first and second flaps 188 and 190 extend from sides of the rectangular opening 207 and define holes 208 that receive the threaded posts 66 on the inflator 44. The third flap 194 extends from a location near a seam or joint between the upper and lower cushions 172 and 174 and defines holes 210 that receive four of the screws 62.

The first, second, third, and fourth tethers 182, 184, 186, and 192 are disposed within the interior of the lower cushion 174 defined by the outer shell 180. The first tether 182 attaches the rear surface 202 of the lower cushion 174 to a first portion of the lower cushion 174 disposed adjacent to the bottom surface 28 of the seat 14 (e.g., a portion of the top surface 196 of the lower cushion 174 adjacent to and/or surrounding the rectangular opening 207). The second tether 184 attaches the bottom surface 198 of the lower cushion 174 to the first portion of the lower cushion 174.

The third tether 186 attaches the front surface 200 of the lower cushion 174 to a second portion of the lower cushion 174 (e.g., a portion of the top surface 196 of the lower cushion 174 disposed below the third flap 194). The fourth tether 192 attaches the left side surface 204 of the lower cushion 174 to the right side surface 206 of the lower cushion 174. The first, second, third, and fourth tethers 182, 184, 186, and 192 may be joined to the outer shell 180 of the lower cushion 174 using stitching 212.

As shown in FIG. 10, each of the first, second, and third mounting strips 167, 168, and 169 defines a different number of holes 214. The two holes 214 in the third mounting strip 169 (shown on the lower left in FIG. 10) and two inner holes 214 in the second mounting strip 168 (shown on the upper left in FIG. 10) receive the threaded posts 66 on the inflator 44. The four outer holes 214 in the second mounting strip 168 receive four of the screws 62. The four holes 214 in the first mounting strip 167 (shown on the upper right in FIG. 10) receive the four of the screws 62. The first, second, and third mounting strips 167, 168, and 169 may be collectively referred to as a cushion mount.

As shown in FIG. 11, the mounting plate 170 defines a generally rectangular opening 216 and a plurality of holes 218 disposed about the perimeter thereof. Two of the inner holes 218 in the mounting plate 170 receive the threaded posts 66 on the inflator 44. The other holes 218 in the mounting plate 170 receive the screws 62. While the first, second, and third mounting strips 167, 168, and 169 collectively include only eight of the holes 214 for the screws 62, the mounting plate 170 includes ten of the holes 218 for the screws 62. Thus, while only eight screws 62 are shown in FIG. 10, the mounting plate 170 may receive ten screws 62. Snap-on washers be placed in or adjacent to the holes 214 or 218 to hold parts together before the nuts 131 are fastened to the screws 62. In addition, a single mounting strip, such as the second mounting strip 168, may be placed inside the airbag cushion 162 adjacent to the inflator 44. The mounting plate 170 may be referred to as a cushion mount.

When the airbag cushion 162 is uninflated as shown in FIG. 7, the tearable cover 164 separates the airbag cushion 162 from the bottom cushion 30 of the seat 14. Then, when the airbag cushion 162 is inflated as shown in FIG. 8, the tearable cover 164 tears to allow the airbag cushion 162 to contact the bottom cushion 30. The material and/or thickness of the tearable cover 164 may be selected to ensure that the tearable cover 164 tears when the airbag cushion 162 is inflated. Additionally or alternatively, the tearable cover 164 may include perforations or seams to ensure that the tearable cover 164 tears when the airbag cushion 162 is inflated.

As shown in FIG. 13, the lower housing 166 includes a bottom wall 220, a plurality of sidewalls 222, and an upper ledge 224. The bottom wall 220 of the lower housing 166 includes a weakened portion 226 that defines a U-shaped tear seam, which forms the boundary of a deployment door 228 for the airbag cushion 162. The upper ledge 224 of the lower housing 166 defines holes 230 and projects outward from the sidewalls 222 so that the screws 62 may be inserted into the holes 230. When the airbag assembly 160 is assembled as shown in FIG. 7, the bottom wall 220 of the lower housing 166 may be only slightly below the bottom surface 28 of the seat 14 so that the airbag assembly 160 does not significantly protrude into the space between the floor panel 12 and the seat 14.

With continued reference to FIGS. 7-13, a method of assembling the airbag assembly 160 will now be described. First, the inflator 44 is placed below the third mounting strip 169 as shown in FIG. 10, and the threaded posts 66 on the inflator 44 are in inserted into the two inner holes 214 of the mounting strip third 169. The inflator 44 may then be secured to the third mounting strip 169 using a snap-on washer (not shown).

Next, the inflator 44 and the third mounting strip 169 are inserted through the rectangular opening 207 in the uninflated airbag cushion 162 and into the interior of the airbag cushion 162. A wiring harness (not shown) may be provided on the inflator 44 so that the wiring harness extends through the rectangular opening 207. The first and second flaps 188 and 190 are then folded over the left mounting strip 168 so that the threaded posts 66 on the inflator 44 are inserted through the holes 208 in the first and second flaps 188 and 190 and so that the wiring harness extends through the rectangular opening 207 around the first and second flaps 188 and 190. After or possibly before the inflator 44 is inserted into the airbag cushion 162, the airbag cushion 162 may be fully or partially folded or rolled as shown in FIGS. 7 and 9 so that the airbag cushion 162 fits between the tearable cover 164 and the lower housing 166. The tearable cover 164 can then be installed and may be held in place using stitches or adhesive disposed around a portion or all of its perimeter.

Ten of the screws 62 are then inserted through the holes 230 in the lower housing 166. The four screws 62 inserted into the holes 230 on the right side of the housing 166 as shown in FIG. 13 are then inserted through the four holes 210 in the fourth flap 194, and the four screws 62 inserted into the holes 230 on the left side of the lower housing 166 as shown in FIG. 13 are then inserted through the four holes 210 in the fifth flap 195. The first and second mounting strips 167 and 168, or the mounting plate 170, are then attached to the airbag subassembly (i.e., the assembled portion of the airbag assembly 160) by routing the screws 62 and the threaded posts 66 through the holes 214 or 218 therein. The nuts 131 are then driven onto the threaded posts 66 to secure the inflator 44 to the airbag subassembly. Snap-on washers can then be installed on the screws 62 to hold the airbag subassembly together before installing the airbag subassembly under the seat 14.

The first and second mounting strips 168 and 169 or the mounting plate 170, with the remainder of the airbag subassembly attached thereto, is/are then placed against the underside surface of the seat frame 32. The screws 62 extending through the third and fourth flaps 194 and 195 and the first and second mounting strips 168 and 169 or the mounting plate 170 are then inserted into corresponding threaded holes in the seat frame 32. More specifically, these screws 62 are inserted into corresponding holes in a cross member 32a of the seat frame 32 and into a U-shaped tube 32b of the seat frame 32. As a result, the airbag subassembly including the first and second mounting strips 168 and 169 or the mounting plate 170 is secured to the seat frame 32. The screws 62 may be inserted into the holes on the shorter sides of the lower housing 166 to secure the airbag subassembly to the seat frame 32 as described above. However, in some cases, the screws 62 may not be inserted into the holes 230 on the shorter sides of the lower housing 166 to secure the airbag subassembly to the seat frame 32 (e.g., the screws 62 may only be inserted into the holes 230 on the longer sides of the lower housing 166 to secure the airbag subassembly to the seat frame 32). Also, the number of the screws 62 and the nuts 110 included in the airbag assembly 160 may be greater or less than described herein, as other fastening techniques (e.g., snap fits) used in airbag construction and seat attachments can be utilized.

Referring now to FIG. 14, an example implementation of the airbag control module 18 of FIG. 1 is shown. While the airbag control module 18 is described with reference to the airbag assembly 16 of FIGS. 1-6, the airbag control module 18 may control the airbag assembly 160 of FIGS. 7-13 in the same manner. The airbag control module 18 includes an occupant detection module 231, an impact magnitude module 232, and an inflator control module 234. The occupant detection module 231 determines whether an occupant is present in the seat 14 based on an input from an occupant detection device such as the weight sensor 138, the capacitive sensor 140, the pressure sensor 142, the camera 144, and/or another type of sensor (not shown).

In one example, the occupant detection module 231 determines that an occupant is present in the seat 14 when the weight measured by the weight sensor 138 is greater than a predetermined weight. In another example, the occupant detection module 231 determines that an occupant is present in the seat 14 when the capacitance measured by the capacitive sensor 140 is greater than a predetermined capacitance. In another example, the occupant detection module 231 determines that an occupant is present in the seat 14 when the seat pressure measured by the pressure sensor 142 is greater than a predetermined pressure. In another example, the occupant detection module 231 determines that an occupant is present in the seat 14 when the image obtained by the camera 144 indicates that an occupant is present in the seat 14.

The impact magnitude module 232 determines a magnitude of an impact in which the vehicle 10 is involved based on an input from the accelerometer(s) 132, the pressure sensor(s) 134, and/or the gyroscope(s) 136. In one example, the impact magnitude module 232 determines the impact magnitude based on a directly proportional relationship between the acceleration (or acceleration waveform characteristics) measured by the accelerometer 132 and the impact magnitude. In another example, the impact magnitude module 232 determines the impact magnitude based on a directly proportional relationship between the pressure (or pressure waveform characteristics) measured by the pressure sensor 134 and the impact magnitude. In another example, the impact magnitude module 232 determines the impact magnitude based on a directly proportional relationship between the angular velocity (or angular velocity waveform characteristics) measured by the gyroscope 136 and the impact magnitude.

The inflator control module 234 controls the inflator 44 to deploy the airbag cushion 46 of FIGS. 1-6 when the vehicle 10 is involved in an impact or collision such as a rear impact. In one example, the inflator control module 234 controls the inflator 44 to deploy the airbag cushion 46 when an occupant is present in the seat 14, the vehicle 10 is involved in a rear impact, and the magnitude of the rear impact is greater than a predetermined value. In another example, the inflator control module 234 controls the inflator 44 to deploy the airbag cushion 46 when the vehicle 10 is involved in a rear impact and the magnitude of the rear impact is greater than the predetermined value, regardless of whether the presence of an occupant in the seat 14 is detected.

The inflator control module 234 controls the inflator 44 to deploy the airbag cushion 162 of FIGS. 7-13 when the vehicle 10 is involved in an impact or collision such as a front impact. In one example, the inflator control module 234 controls the inflator 44 to deploy the airbag cushion 162 when an occupant is present in the seat 14, the vehicle 10 is involved in a front impact, and the magnitude of the front impact is greater than a predetermined value. In another example, the inflator control module 234 controls the inflator 44 to deploy the airbag cushion 162 when the vehicle 10 is involved in a front impact and the magnitude of the front impact is greater than the predetermined value, regardless of whether the presence of an occupant in the seat 14 is detected.

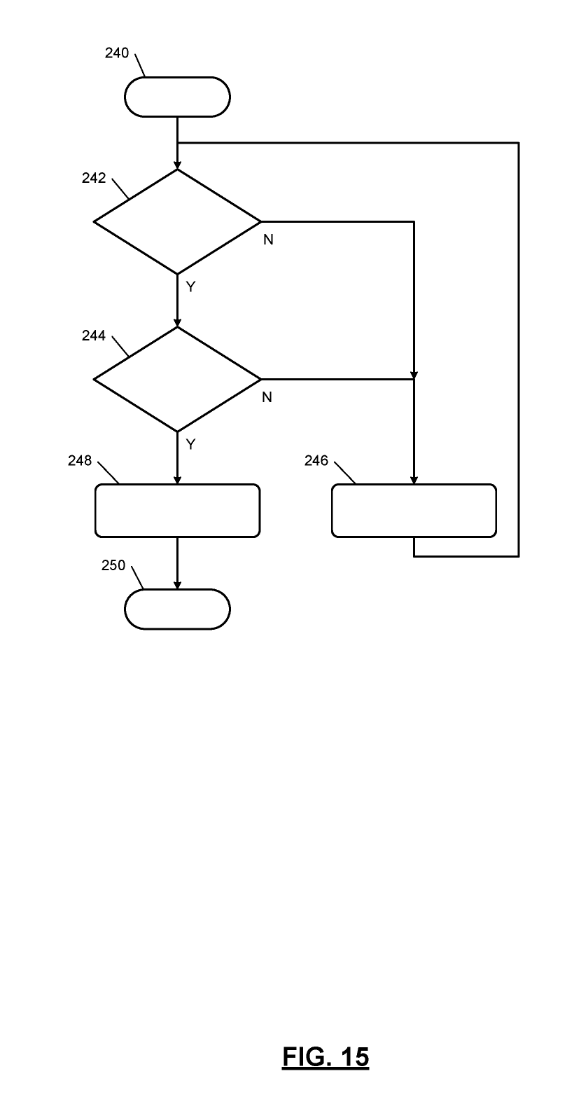

Referring now to FIG. 15, an example method of controlling an airbag assembly according to the present disclosure starts at 240. The method is described in the context of the modules of FIG. 14. However, the particular modules that perform the steps of the method may be different than the modules mentioned below, or the method may be implemented apart from the modules of FIG. 14. In addition, while the method is described with reference to the airbag assembly 16 of FIGS. 1-6, the method may be used to control the airbag assembly 160 of FIGS. 7-13 in the same manner.

At 242, the occupant detection module 231 determines whether an occupant is present in the seat 14 of the vehicle 10 of FIG. 1. If an occupant is present in the seat 14, the method continues at 244. Otherwise, the method continues at 246. At 246, the inflator control module 234 controls the inflator 44 to not deploy the airbag cushion 46.

At 244, the impact magnitude module 232 determines whether the vehicle 10 is involved in a rear impact have a magnitude greater than a first threshold (e.g., a predetermined value). If the vehicle 10 is involved in a rear impact having a magnitude greater than the first threshold, the method continues at 248. Otherwise, the method continues at 246. At 248, the inflator control module 234 controls the inflator 44 to deploy the airbag cushion 46. The method ends at 250.

If the method of FIG. 15 is used to control the airbag assembly 160 of FIGS. 7-13, 244-248 may be modified relative to the above description. In one example, at 244, the impact magnitude module 232 determines whether the vehicle 10 is involved in a front impact have a magnitude greater than a second threshold (e.g., a predetermined value). If the vehicle 10 is involved in a front impact having a magnitude greater than the second threshold, the method continues at 248. Otherwise, the method continues at 246. At 248, the inflator control module 234 controls the inflator 44 to deploy the airbag cushion 162.

In various implementations of the method of FIG. 15, 242 may be omitted. In these implementations, the method continues directly to 244 from 240. In addition, the method continues directly to 244 from 246.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An airbag assembly comprising:
an airbag cushion;
a cushion mount configured to mount the airbag cushion under a seat of a vehicle; and
an inflator configured to inflate the airbag cushion, wherein the airbag cushion is configured to project toward a floor of the vehicle and at least partially fill a space between a bottom surface of the seat and the floor of the vehicle when the airbag cushion is inflated to provide a reaction surface for a back surface of a leg of a passenger in the seat.

2. The airbag assembly of claim 1 wherein the airbag cushion is configured to project toward the floor of the vehicle and forward of the seat when the airbag cushion is inflated.

3. The airbag assembly of claim 1 further comprising at least one tether disposed within the airbag cushion and attaching a first portion of an inner surface of the airbag cushion to at least one of the cushion mount and a second portion of the inner surface of the airbag cushion adjacent to the bottom surface of the seat.

4. The airbag assembly of claim 3 wherein the at least one tether includes at least one of a first tether and a second tether, the first tether attaching a rear portion of the inner surface of the airbag cushion to the second portion of the inner surface of the airbag cushion, the second tether attaching a front portion of the inner surface of the airbag cushion to the second portion of the inner surface of the airbag cushion.

5. The airbag assembly of claim 4 wherein the at least one tether includes the first tether, the second tether, and a third tether, the third tether attaching a bottom portion of the inner surface of the airbag cushion to the second portion of the inner surface of the airbag cushion.

6. The airbag assembly of claim 1 further comprising a tethered vent configured to:
remain open to release gas from an interior of the airbag cushion when an object is in a deployment path of the airbag cushion; and
close to prevent gas from escaping the interior of the airbag cushion when the airbag cushion is fully deployed.

7. The airbag assembly of claim 1 further comprising an upper housing and a lower housing configured to cooperate with the upper housing to fully enclose the airbag cushion.

8. The airbag assembly of claim 1 further comprising a deployment door configured to:
remain closed and cover a bottom surface of the airbag cushion when the airbag cushion is uninflated; and
open in a direction away from the leg of the passenger and allow the airbag cushion to project toward the floor and at least partially fill the space between the bottom surface of the seat and the floor when the airbag cushion is inflated.

9. The airbag assembly of claim 8 further comprising a housing configured to at least partially enclose the airbag cushion when the airbag cushion is uninflated, wherein the deployment door is part of the housing.

10. The airbag assembly of claim 1 wherein the cushion mount includes a mounting plate and a plurality of fasteners configured to extend through the mounting plate, through the airbag cushion, and into a frame of a bottom portion of the seat to secure the airbag cushion to the seat.

11. The airbag assembly of claim 1 wherein the airbag cushion is configured to project upward into a bottom cushion of the seat to raise a thigh of the passenger when the airbag cushion is inflated to prevent the passenger from sliding forward underneath a seat belt of the seat.

12. The airbag assembly of claim 11 further comprising a cover configured to:
separate the airbag cushion from the bottom cushion of the seat when the airbag cushion is uninflated; and
tear to allow the airbag cushion to contact the bottom cushion of the seat when the airbag cushion is inflated.

13. The airbag assembly of claim 1 further comprising an inflator control module configured to control the inflator to deploy the airbag cushion when the vehicle is involved in at least one of a rear impact and a front impact relative to the passenger and a magnitude of the at least one of the rear impact and the front impact is greater than a predetermined value.

14. The airbag assembly of claim 1 further comprising an inflator control module configured to control the inflator to deploy the airbag cushion when an occupant is present in the seat, the vehicle is involved in at least one of a rear impact and a front impact relative to the occupant, and a magnitude of the at least one of the rear impact and the front impact is greater than a predetermined value.

15. The airbag assembly of claim 1 further comprising an inflator control module configured to control the inflator to not deploy the airbag cushion when an occupant is not present in the seat.

16. The airbag assembly of claim 1 further comprising at least one tether disposed within the airbag cushion and attaching a left side portion of an inner surface of the airbag cushion to a right side portion of the inner surface of the airbag cushion.

17. An airbag assembly comprising:
an airbag cushion including an upper portion and a lower portion;
a cushion mount configured to mount the airbag cushion under a seat of a vehicle; and
an inflator configured to inflate the airbag cushion, wherein the upper portion of the airbag cushion is configured to project upward into a bottom cushion of the seat to raise a thigh of a passenger in the seat when the airbag cushion is inflated to prevent the passenger from sliding forward underneath a seat belt of the seat, and the lower portion of the airbag cushion is configured to project toward a floor of the vehicle and at least partially fill a space between a bottom surface of the seat and the floor of the vehicle when the airbag cushion is inflated.

18. The airbag assembly of claim 17 further comprising a cover configured to:
separate the airbag cushion from the bottom cushion of the seat when the airbag cushion is uninflated; and
tear to allow the airbag cushion to contact the bottom cushion of the seat when the airbag cushion is inflated.

19. The airbag cushion of claim 17 wherein the cushion mount includes a pair of mounting strips and a plurality of fasteners configured to extend through the pair of mounting strips, through the airbag cushion, and into a frame of a bottom portion of the seat to secure the airbag cushion to the seat.

20. The airbag cushion of claim 17 wherein the cushion mount includes a mounting plate and a plurality of fasteners configured to extend through the mounting plate, through the airbag cushion, and into a frame of a bottom portion of the seat to secure the airbag cushion to the seat.
